(19) United States
(12) Patent Application Publication
(10) Pub. No.: US 2009/0009881 A1
(43) Pub. Date: Jan. 8, 2009

(54) Control of Electrowetting Lenses

(75) Inventors: Ivon Franciscus Helwegen, Herten (NL); Bernardus Hendrikus Hendriks, Eindhoven (NL); Stein Kuiper, Vught (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., ENDHOVEN (NL)

(21) Appl. No.: 12/160,220

(22) PCT Filed: Jan. 4, 2007
(86) PCT No.: PCT/IB2007/050017

§ 371 Date: Jul. 8, 2008

(30) Foreign Application Priority Data
Jan. 11, 2006 (EP) 06100252.3

(51) Int. Cl. G02B 3/14

(52) U.S. Cl. 359/666

(57) ABSTRACT

A control circuit (40) for electrowetting lenses (41, 42) includes a driver circuit (45) for producing a controllable voltage supply (46) and a first (43) and a second (44) voltage modulator, each connected to receive the controllable voltage supply. The first and second voltage modulators are configured to respectively produce first (32) and second (33) modulated voltage outputs from the voltage supply. A controller (49) receives at least one set point signal (53, 52) and, as a function thereof, (i) controls the driver circuit to produce the voltage supply, and (ii) controls the first and second voltage modulators to produce the first and second modulated outputs.

This invention relates to electrical control of high voltage elements, such as electrowetting lenses, and to control circuits and methods for controlling focus and zoom of such lenses.

Conventional lens assemblies for cameras with both focus and zoom facilities require multiple lens elements, which are typically solid with fixed surface curvatures. These lens elements may be grouped in various combinations. Movement of more than one lens in such an assembly enables both focus and zoom. Because of the requirement for mechanical movement, zoom lens assemblies made using conventional solid lenses require additional space along the optical axis of the assembly to accommodate the additional movement. Also, one or more actuators and various mechanical parts are generally required to obtain controllable mechanical movement. Problems associated with such systems include consumption of electric energy in driving electric motors, mechanical vulnerability of complex and delicate moving parts, and limits on the ability to miniaturise the assembly.

An alternative solution for focus and zoom, particularly suitable for miniature cameras, is the use of so-called electrowetting lenses. Such lenses consist of two clear and immiscible fluids of differing refractive indices contained within a fluid chamber which contact each other at an interface. Applying an electric field across a wall of the fluid chamber causes the contact angle of the meniscus formed at the interface to change, and thus alters the focusing property of the lens. Importantly, the whole lens does not need to be displaced in the optical path in order to alter its focusing properties.

By combining two such electrowetting lenses with additional appropriate fixed lenses a zoom facility is enabled without the need for any mechanical displacement of the lenses. This can considerably reduce the mechanical complexity of the lens assembly, increase its robustness and minimise the size of the assembly required for a given zoom facility and focusing range compared with an equivalent assembly of solid lenses. Another advantage of a zoom facility using electrowetting lenses is that a change of zoom can be carried out very quickly, typically much faster than with conventional motors or actuators. A complete zoom range may be switched within 10 ms.

One example of a zoom lens assembly comprising electrowetting lenses is disclosed in WO 2004/038480, where two independently controllable electrowetting lenses are contained within a single fluid chamber. Both zoom and focusing are possible by varying the drive voltage to both lenses. Separately controllable voltage sources are used to drive each lens.

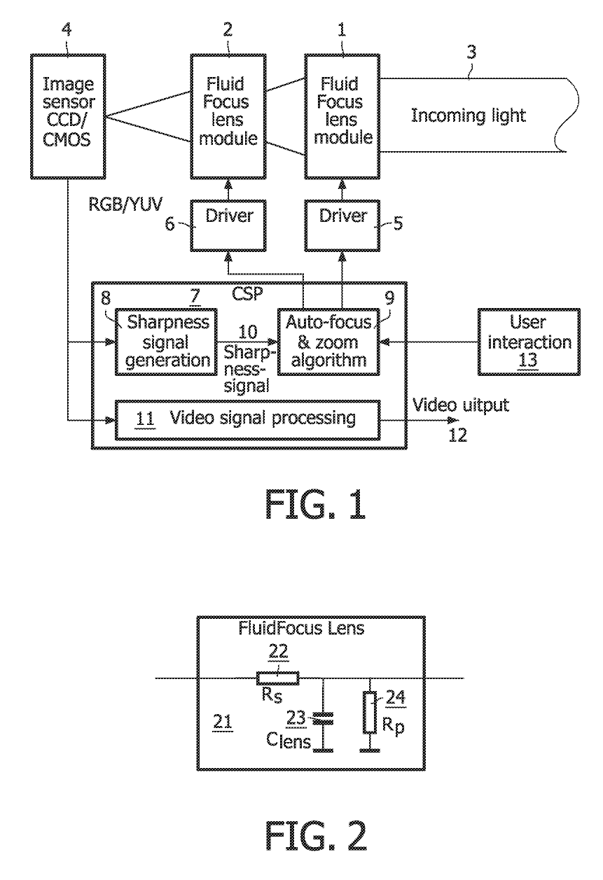

A schematic block diagram of a digital camera module comprising a control system for an auto focus and zoom assembly using two electrowetting lenses is shown in FIG. 1. The incoming light 3 is focused onto the image sensor 4 by passing through a first electrowetting lens 1 and a second electrowetting lens 2. Other fixed lenses (not shown) may also be positioned ahead of, behind or between the lenses 1, 2. The first lens 1 is controlled by the first driver 5, while the second lens 2 is controlled by the second driver 6. Each driver 5, 6 applies a control voltage to its respective lens 1, 2.

The image sensor 4 converts the incoming light 3 into an electrical signal that can be stored in memory. The image sensor 4 generates a RGB or YUV signal from the image, which is then fed to the camera signal processor (CSP) 7. A video signal processor 11 in the CSP processes the signal from the image sensor 4 and outputs a video output signal 12. A sharpness signal generator 8 also processes the signal from the image sensor 4 and generates a sharpness signal 10. The sharpness signal 10, which may be generated for example from high frequency components of the image information, is representative of the level of sharpness of the image at any given moment. An auto focus and zoom algorithm 9 takes the sharpness signal and generates an error signal from the differences in sharpness signals. For focusing, the algorithm 9 contains a control loop that converts the error signal into a lens driver signal, which is supplied to the appropriate lens via one of the drivers 5, 6.

For zoom, the auto focus and zoom algorithm 9 receives the user input 13 and generates two lens driver signals, which are sent to the drivers 5, 6 and thence to the lenses 1, 2. While one lens may control the level of zoom of the lens assembly, changing the focal length of only one lens will result in the image going out of focus, and therefore a further adjustment will be required to the second lens to compensate for this. Advantageously, this operation is carried out synchronously, since for any given zoom level there will be a predetermined focusing level for any given object distance. An alteration of the zoom level can therefore be made while simultaneously maintaining the same object distance as set by the CSP.

One problem with prior art solutions is that two separate driver and voltage sources are used. For cameras incorporating electrowetting lenses for focus and zoom, two high-voltage driver integrated circuits (ICs) are therefore needed. This has two main disadvantages. Firstly, in portable small form factor applications, such as mobile phones or small digital cameras, two ICs together with their peripheral electronics need more printed circuit board area. Secondly, high voltage drivers, such as up-converters or charge pumps, have quite low efficiency and consume significant levels of power, so the power consumption of the driver electronics of such a solution doubles.

It is an object of the invention to facilitate the use of a single high voltage supply for driving focus and zoom lenses.

According to one aspect, the invention provides a control circuit for electrowetting lenses, comprising:

a driver circuit for producing a controllable voltage supply;

a first and a second voltage modulator, each connected to receive the controllable voltage supply and adapted to respectively produce first and second modulated voltage outputs therefrom;

a controller adapted to receive at least one set point signal and, as a function thereof, (i) control the driver circuit to produce said voltage supply and (ii) control the first and second voltage modulators to produce said first and second modulated outputs.

According to a further aspect, the invention provides a method of controlling focus and/or zoom operation of a camera including a first and a second electrically controllable lens, comprising:

receiving a set point signal;

based on the set point signal, determining a first and a second voltage value required for controlling respective ones of the lenses;

adjusting a driver to produce a voltage output at least as high as the higher of the first and second voltage values;

controlling a first and a second voltage modulator to produce from the voltage supply a first and a second modulated voltage output corresponding to the first and second voltage values; and

driving the first and second lenses with the first and second modulated voltage outputs respectively.

Embodiments of the present invention will now be described by way of example and with reference to the accompanying drawings in which:

FIG. 1 shows a schematic block diagram of a digital camera utilising electrowetting lenses;

FIG. 2 illustrates a simplified equivalent electrical circuit for an electrowetting lens;

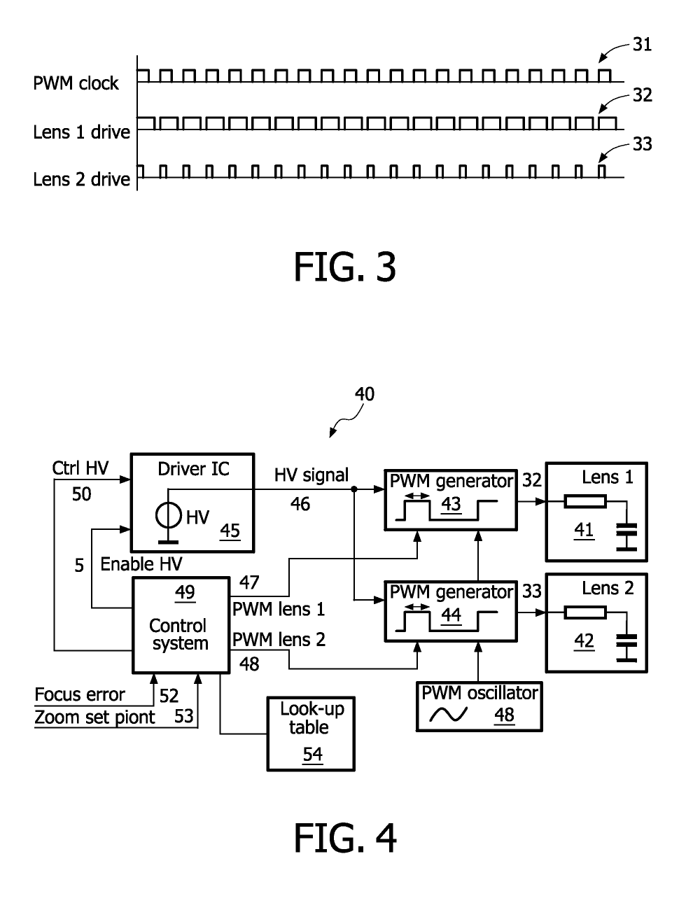

FIG. 3 illustrates a pulse width modulation scheme for driving two electrowetting lenses;

FIG. 4 illustrates a block diagram of a focus and zoom system;

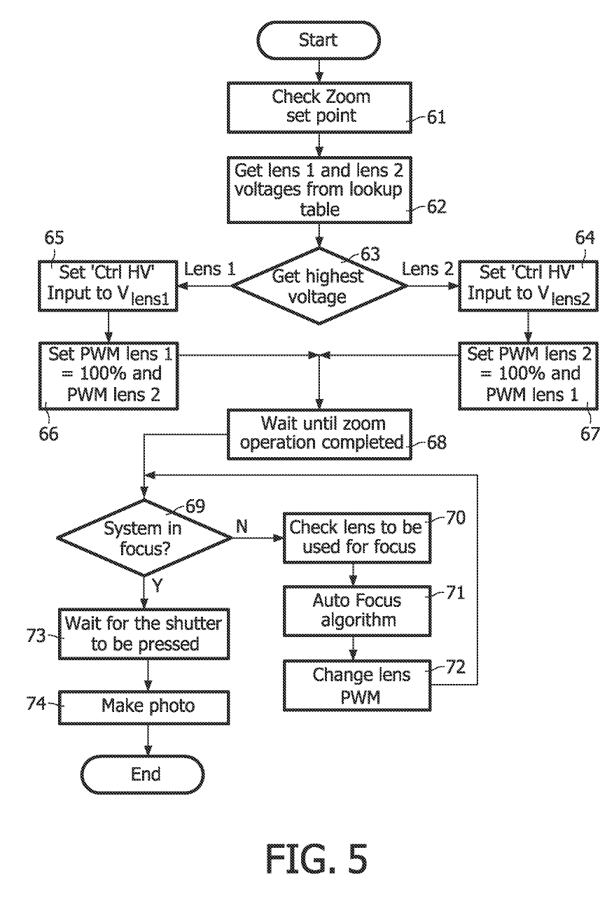

FIG. 5 illustrates a flowchart of an exemplary lens driving algorithm;

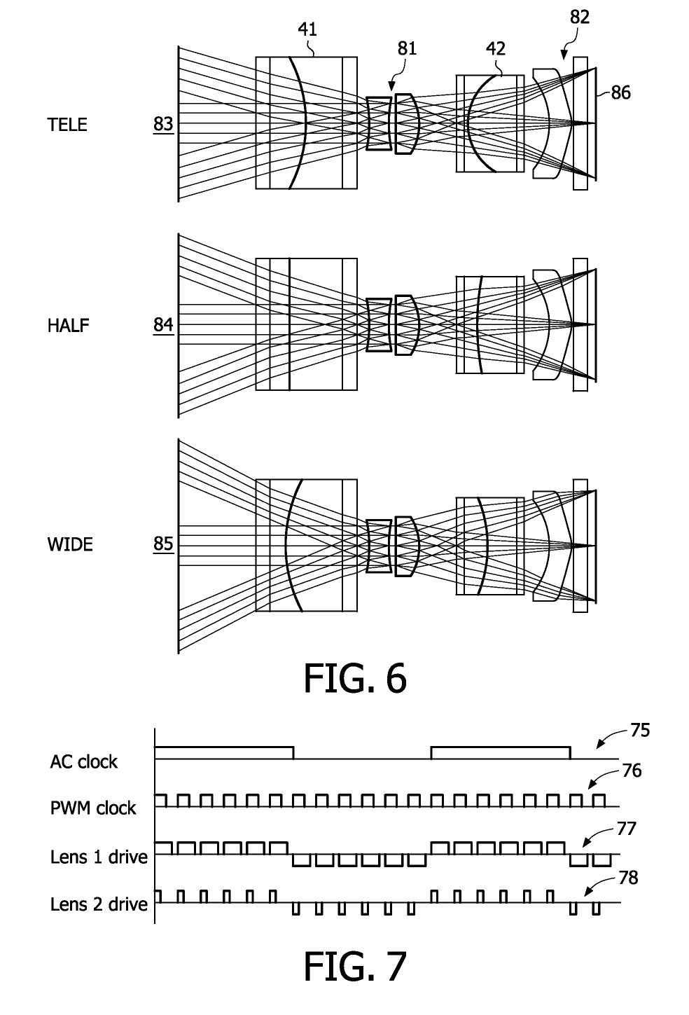

FIG. 6 illustrates an example of a zoom lens based on two electrowetting lenses in three different modes of operation;

FIG. 7 illustrates an example of PWM signals for an AC drive scheme; and

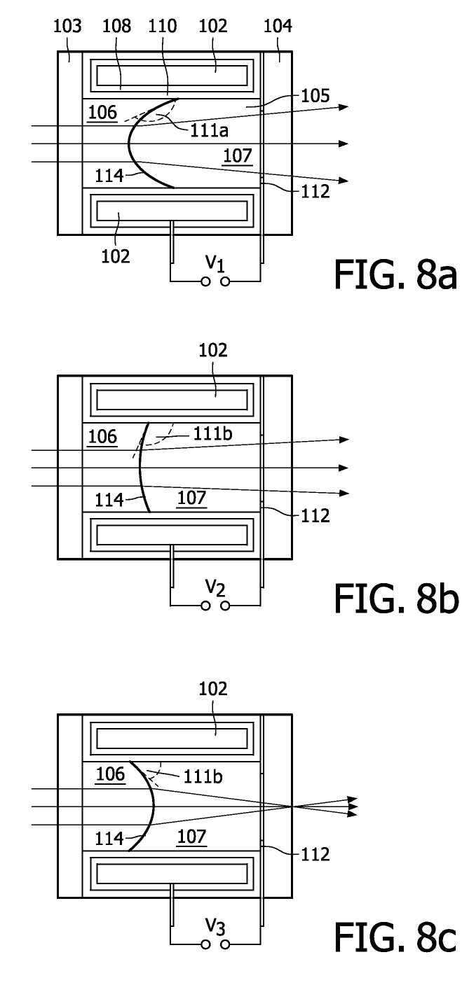

FIGS. 8a to 8c illustrate a schematic cross section of an adjustable electrowetting lens.

The invention makes use of the low pass electrical filter properties of electrowetting lenses. FIG. 2 illustrates a simplified equivalent electrical circuit of an electrowetting lens 21. The lens 21 can be characterised by a lens capacitance Cₗₑₙₛ 23, a series resistance Rₛ 22 and a parallel resistance Rₚ 24. The series resistance 22 together with the lens capacitance 23 act as a low pass filter. The parallel resistance 24, which represents the DC electrical leakage across the lens, is typically sufficiently high to be neglected.

The low pass filter is characterised by a frequency f at which the output is −3 dB relative to the input, given by

$$f = \frac{1}{2 π {R}_{s} {C}_{lens}} \qquad [ 1 ]$$

Therefore, an alternating voltage signal applied to the electrowetting lens 21 will be filtered by the properties of the lens itself, with the effect that high frequency components will pass through the lens, and only low frequency components will form the signal that significantly alters the focusing properties of the lens.

A digitally switched signal, such as by a pulse width modulation (PWM) scheme, may therefore be applied directly to the electrowetting lens 21 as a driving signal. The high frequency switching components of the signal will be filtered, while the DC voltage level component will be applied across the lens.

For a typical electrowetting lens, the value for f is of the order of a few MHz. Switching a PWM signal at such high frequencies would result in a large amount of current passing through the lens and therefore a high power consumption. However, due to the mechanical restraints of the lens components related to the speed at which the fluid interface can alter its shape, the effective −3 dB frequency is at around 100 Hz. A switching frequency of as low as 5 to 10 kHz can therefore be used, resulting in a more modest loss of power via passage of high frequency components through the lens.

FIG. 3 illustrates an exemplary driving scheme for PWM signals applied to two electrowetting lenses. A PWM clock pulse signal 31 dictates the switching frequency of the two separate driving signals 32, 33. A first driving signal 32 is applied to the first lens 1, and results in a driving voltage across the lens meniscus that varies as a function of the duty cycle of the first signal, the duty cycle being defined as being the ratio between the duration over each clock cycle of the on and off states of the signal. A second driving signal 33 is applied to the second lens 2, which in this particular case results in a lower driving voltage due to the relatively lower duty cycle.

Using the scheme shown in FIG. 3 to drive two electrowetting lenses requires only a single high voltage source, which can be modulated via two pulse width modulators, each driven at a duty cycle that is calculated to vary in accordance with the level of DC voltage required across each lens.

Illustrated in FIG. 4 is a schematic representation of a control circuit 40 for driving two electrowetting lenses using the modulation scheme of FIG. 3. First 41 and second 42 electrowetting lenses are connected to first 43 and second 44 voltage modulators, which in this case operate via pulse width modulation. The modulators 43, 44 are controlled by a controller 49 via control signals 47, 48. The control signals 47, 48 control the duty cycle of each of the respective voltage modulators 43, 44. The controller 49 also controls, via a high voltage control signal 50 and an enable signal 51, the operation of a high voltage driver module 45. The high voltage driver module 45 supplies a high voltage signal 46 to the voltage modulators 43, 44 according to the signal 50 received from the controller.

A focus error signal 52 and a zoom set point signal 53 form inputs to the controller, from which the controller derives the various signals 50, 51, 47, 48 to drive the electrowetting lenses 41, 42.

The control circuit of FIG. 4 may be configured such that the high voltage signal 46 is set to a level that is just high enough to drive the higher of the two signals required to drive each of the electrowetting lenses 41, 42. This has the advantage that the efficiency of operation of the high voltage driver module 45 is maximised. Since only one high voltage driver module 45 is used, this control circuit has reduced cost and size compared with using two separate variable high voltage driver circuits.

Thus, in a general aspect, the controller 49 is preferably configured to set the high voltage supply to a level which is at or close to the level required for the higher of the two lens driving signals 32, 33, and to control a first one of the voltage modulators to produce a modulated voltage output at or close to the high voltage supply level, and to control a second one of the voltage modulators to produce a modulated voltage output at a level that is significantly less than the high voltage supply level. The expression ‘level’ used here of course refers to the average level taking into account any modulation such as PWM.

In applications with mechanical actuators, focus and zoom lenses may be mechanically coupled, such that a second lens will automatically move when a first lens is moved. This enables such a system to vary the zoom function whilst maintaining a given object distance. An equivalent behaviour may be achieved electronically using the system of FIG. 4 by altering the high voltage control signal 50 while maintaining the control signals 47, 48, thereby altering the focus of each lens 41, 42 by the same proportion. A further fine-tuning operation via the focus error signal 52 may then be used to obtain the correct focus.

In order to efficiently drive the lenses 41, 42, the voltages for any given focus and zoom level are preferably obtained from a look-up table 54, which is either contained within the controller 49 or external to and queried by the controller 49. Entries to the look-up table may consist of values based on the focus error signal 52 and/or the zoom set point signal 53. Outputs from the table may consist of values from which the high voltage control signal 50, the enable signal 51, the first control signal 47 and the second control signal 48 are determined. The values output from the look-up table may be the voltages themselves, or alternatively may be values from which the voltages can be determined.

Illustrated in FIG. 5 is an algorithm in the form of a flow chart for operation of the controller 49. Following the start of the algorithm, the controller 49 checks the zoom set point signal 53 at step 61. Given this zoom set point signal 53 and the present set point of the object distance, appropriate levels for the voltages to be used to drive the first 41 and second 42 lenses are obtained from a lookup table at step 62. At step 63, the controller determines which is the higher of the two voltages, proceeding to step 65 in the case of the first lens voltage being higher or to step 64 in the case of the second lens voltage being higher. In steps 64 or 65 the ‘Ctrl HV’ signal 50 is set to the appropriate level, based on the higher lens driving voltage. At step 66 or 67 the duty cycle for the appropriate voltage modulator is set to 100%, while the duty cycle for the other modulator is set to a proportionately reduced value.

For example, if the first lens 41 requires a voltage of 20 V while the second lens 42 requires a voltage of 70 V, the ‘Ctrl HV’ input 50 is set to 70 V. This has the advantage of making the circuit more efficient, since setting ‘Ctrl HV’ 50 to a higher voltage would result in a high power consumption for no additional benefit. The PWM duty cycle for the second voltage modulator is then set to 100%, thus providing the second lens with the full high voltage signal 46. The duty cycle for the first voltage modulator is set to 20/70=28.6%.

The controller then, at step 68, waits until the zoom operation is complete, e.g. by waiting a predetermined delay time or waiting for a feedback control signal. The controller then checks whether the focus needs to be altered, at step 69. If the system is not in focus, i.e. if the focus error signal 52 is not minimised, the controller first checks, at step 70, which lens needs to be used to alter the object distance of the assembly. The controller then calls, at step 71, an auto-focus algorithm to estimate by how much one or both of the lenses needs to be changed to bring the image into focus. At step 72, the controller changes the duty cycle of the appropriate voltage modulator 43, 44 by an appropriate amount. The loop then repeats until the image is brought into focus.

Once the system is in focus, i.e. the focus error signal 52 is minimised, the controller waits for the shutter button to be pressed (step 73). Once the button has been pressed, the photo is taken (step 74) and the process ends.

An example of a zoom lens design utilising two electrowetting lenses is shown schematically in FIG. 6. In this example, the two electrowetting lenses 41, 42 are separated by a first fixed focus lens assembly 81. A second fixed focus lens assembly 82 is positioned between the second electrowetting lens 42 and an image plane 86. FIG. 6 illustrates light paths in three modes, being that of ‘tele’, ‘half’ and ‘wide’, corresponding to maximum, half and minimum zoom levels respectively. The field of view at the image plane 86 is widest in the ‘wide’ mode, and narrowest in the ‘tele’ mode. The extent of the incoming light rays 83, 84, 85 is illustrated in each mode being focused on to the image plane 86. Altering the applied voltage to each lens 41, 42 enables the same object distance to be maintained at each zoom level.

FIG. 7 illustrates an alternative pulse width modulation scheme, in which an AC drive signal is to be used to drive each lens 41, 42. An AC clock signal 75 is provided together with a PWM clock signal 76. This results in a first lens driving signal 77 and a second lens driving signal 78. In this example, the PWM clock frequency given by the PWM clock signal 76 is synchronised with the frequency of the AC drive signal 75 such that the PWM clock frequency is an integer multiple of the AC drive signal frequency. The AC clock signal is superimposed on the lens drive signals such that the signals 77, 78 are inverted for periods when the AC clock signal is at zero.

The driving scheme shown in FIG. 7 has the effect of driving the lenses 41, 42 with an alternating voltage, comprising a fundamental frequency at the AC clock signal frequency together with higher harmonics, some or all of which may be filtered by the lenses 41, 42 themselves.

Although the above description applies to the lens driving signals being generated by pulse width modulation, there are other possibilities that lie within the scope of the invention that may be used to generate the required voltages for the lenses 41, 42. One such alternative example is that of a resistor network that can be switched to generate different driving voltages. Such an example may take the form of a voltage divider with a variable resistor or an array of resistors that can be switched. In order to minimise the power loss in the resistor network, high values of resistance are needed, which will increase the settling time of the focusing and zooming methods due to charging and discharging of the lens capacitances. Also, an increased area of an integrated circuit incorporating the resistor network will be required for larger resistors.

In a general aspect, illustrated in FIGS. 8a to 8c is an example variable focus electrowetting lens of a type suitable for use with the present invention. The electrowetting lens comprises a cylindrical first electrode 102 forming a capillary tube, sealed by means of a transparent front element 103 and a transparent back element 104 to form a fluid chamber 105 containing two fluids 106, 107. The electrode 102 may be an electrically conductive coating applied on the inner wall of a tube.

The two fluids 106, 107 consist of two immiscible liquids in the form of an electrically insulating first liquid 106, such as a silicone oil or an alkane, and an electrically conducting second liquid 107, such as an aqueous salt solution. The two liquids are preferably arranged to have an equal density, so that the lens functions independently of orientation, i.e. without dependence on gravitational effects between the two liquids. This may be achieved by appropriate selection of the first liquid constituent; for example alkanes or silicone oils may be modified by addition of molecular constituents to increase their density to match that of the salt solution.

The fluids in this example are selected such that the first fluid 106 has a higher refractive index than that of the second fluid 107.

The first electrode 102 is a cylinder of inner radius typically between 1 mm and 20 mm. The electrode 102 is formed from a metallic material and is coated by an insulating layer 108, formed for example of parylene. The insulating layer has a typical thickness of between 1 μm and 10 μm. The insulating layer is coated with a fluid contact layer 110, which reduces the hysteresis in the contact angle of the meniscus with the cylindrical wall of the fluid chamber. The fluid contact layer is preferably formed from an amorphous fluorocarbon such as polytetrafluoroethene (PTFE). The fluid contact layer 110 has a thickness of between 5 nm and 50 μm. The wettability of the fluid contact layer 110 by the second fluid 107 is preferably substantially equal on both sides of the intersection of the meniscus 114 with the fluid contact layer 110 when no voltage is applied between the first 102 and second 112 electrodes.

A second, annular electrode 112 is arranged at one end of the fluid chamber, in this case, adjacent the back element 104. The second electrode 112 is arranged with at least one part in the fluid chamber such that the electrode 112 acts on the second fluid 107.

The two fluids 106, 107 are non-miscible so as to tend to form two fluid bodies separated by a meniscus 114. When no voltage is applied between the first and second electrode, the fluid contact layer 110 has a higher wettability with respect to the first fluid 106 than the second fluid 107. Due to electrowetting, the wettability by the second fluid 107 varies under the application of a voltage between the first electrode 102 and the second electrode 112, which tends to change the contact angle 111a-c of the meniscus 114 at the three phase line (the line of contact between the fluid contact layer 110 and the two liquids 106, 107). The shape of the meniscus 114 is thus variable in dependence on the applied voltage.

When a low voltage V₁, e.g. between 0 V and 20 V, is applied between the electrodes 102, 112, the meniscus 114 adopts a first concave meniscus shape. In this configuration, the initial contact angle 111a between the meniscus 114 and the fluid contact layer 110, measured in the second fluid 107 is for example 140°. Due to the higher refractive index of the first fluid 106 than the second fluid 107, the lens formed by the meniscus 114 has a relatively high negative power in this configuration.

To reduce the concavity of the meniscus shape, a higher magnitude of voltage is applied between the first 102 and second 112 electrodes. Referring to FIG. 8b, when an intermediate voltage V₂, e.g. between 20 V and 150 V (depending on the thickness of the insulating layer 108) is applied between the electrodes 102, 112, the meniscus 114 adopts a second curvature increased in comparison with the meniscus 114 in FIG. 8a. In this configuration, the intermediate contact angle 111b between the meniscus 114 and the fluid contact layer 110 is for example approximately 100°. Due to the higher refractive index of the first fluid 106 than the second fluid 107, the meniscus lens in the configuration has a relatively low negative power.

To produce a convex meniscus shape, a yet higher magnitude of voltage is applied between the first 102 and second 112 electrodes. Referring to FIG. 8c, when a relatively high voltage V₃, e.g. 150 V to 200 V, is applied between the electrodes the meniscus adopts a convex shape. In this configuration the contact angle 111c between the meniscus 114 and the fluid contact layer 110 is for example approximately 60°. Due to the higher refractive index of the first fluid 106 than the second fluid 107, the meniscus lens in this configuration has a positive power.

The change in contact angle θ of the conducting liquid 107 with the fluid contact layer can be described by:

$$cos θ = cos {θ}_{0} + \frac{ɛ {V}^{2}}{2 {γ}_{ci} {d}_{f}} \qquad [ 2 ]$$

where θ₀ is the contact angle in the ‘off’ state, i.e. with no applied voltage, ∈ is the dielectric constant of the insulating layer 108, d_{f} the thickness of the insulating layer, γ_{ci} the interfacial tension between the liquids 106, 107 and V the applied voltage. Equation [2] is valid if an initial contact angle θ₀ exists, i.e. i\tilde{f}<θ₀<180°. However, this may not be the case, particularly for fluorocarbon coatings, such as PTFE. If the interfacial tension γ_{wc} between the wall and the conducting liquid 107 is larger than the sum of the interfacial tension γ_{wi} between the wall and the insulating liquid 106 and the liquid/liquid interfacial tension γ_{ci}, the formation of a thin oil film between the conductive liquid and the wall will be energetically favourable. In this case the contact angle is not defined, as there is no direct contact between the wall and the conducting liquid. The exact equation is:

$$cos θ = \frac{{γ}_{wi} - {γ}_{wc}}{{γ}_{ci}} + \frac{ɛ {V}^{2}}{2 {γ}_{ci} {d}_{f}} for - 1 \leq cos θ \leq 1 \qquad [ 3 ]$$

In the above case the term (γ_{wi}−γ_{wc})/γ_{ci} is smaller than −1. Equation [3] therefore becomes valid only above a certain threshold voltage. Below this voltage the contact angle is effectively 180°.

Furthermore, the relation between the contact angle θ, the inner radius of the cylinder R_{c} and the radius of curvature of the meniscus Rₘ is given by

$$cos θ = - \frac{{R}_{c}}{{R}_{m}} \qquad [ 4 ]$$

So in the case where (γ_{wi}−γ_{wc})/γ_{ci} is approximately −1, we find

$$\frac{{R}_{c}}{{R}_{m}} = 1 - \frac{ɛ {V}^{2}}{2 {γ}_{ci} {d}_{f}} \qquad [ 5 ]$$

Tables of the three different zoom configurations of FIG. 6 in terms of the field of view and the Rₘ/R_{c} values for the first 41 and second 42 electrowetting lenses are shown below. In table 1 the values are given for three different zoom levels at infinite object distance. Tables 2 and 3 show how these values are altered for two further exemplary object distances at each zoom level, showing the values for the first lens 41 in table 2 and for the second lens 42 in table 3.

TABLE 1
lens settings for infinite object distance

| Zoom | Field of | Rₘ/R_{c}- | Rₘ/R_{c}- |
|---|---|---|---|
| configuration | view/degrees | first lens | second lens |
| Tele | 32 | −2.15 | 2.32 |
| Half | 42 | 196.78 | 5.26 |
| Wide | 56 | 2.09 | −1.11 |

TABLE 2
first lens settings for different object distances

| Zoom | Rₘ/R_{c}- | Rₘ/R_{c}- | Rₘ/R_{c}- |
|---|---|---|---|
| configuration | infinite | 20 cm | 10 cm |
| Tele | −2.15 | −2.43 | −2.68 |
| Half | 196.78 | 17.51 | 9.28 |
| Wide | 2.09 | 1.92 | 1.77 |

TABLE 3
second lens settings for different object distances

| Zoom | Rₘ/R_{c}- | Rₘ/R_{c}- | Rₘ/R_{c}- |
|---|---|---|---|
| configuration | infinite | 20 cm | 10 cm |
| Tele | 2.32 | 2.15 | 1.93 |
| Half | 5.26 | 8.45 | 24.46 |
| Wide | −1.11 | −1.21 | −1.34 |

It will be understood that although the exemplary embodiments described above show control of just two electrowetting lenses using a single high voltage supply, the principles described can extend to more than two independently controllable lenses each with a respective modulator circuit.

It will also be understood that the invention is applicable not only to controlling electrowetting lenses, but may also be applicable in other applications where multiple high voltage driving schemes are necessary. For example, other electrowetting devices such as electrowetting diaphragms may be driven using the control circuit of the invention. Other devices requiring multiple high voltage driving signals, such as for piezoelectric actuators or electroluminescent backlights, may also be suitable for use with the invention.

Other embodiments are envisaged to be within the scope of the appended claims.

1. A control circuit for electrowetting lenses, comprising:
a driver circuit for producing a controllable voltage supply;
a first and a second voltage modulator, each connected to receive the controllable voltage supply and adapted to respectively produce first and second modulated voltage outputs;
a controller adapted to receive at least one set point signal, control the driver circuit to produce said voltage supply and control the first and second voltage modulators to produce said first and second modulated outputs.

2. The control circuit of claim 1, wherein the controller is adapted to receive the at least one set point signal in the form of a zoom set point signal and a focus error signal.

3. The control circuit of claim 1, wherein the first and second voltage modulators are each adapted to modulate the controllable voltage supply by pulse width modulation to produce said first and second modulated outputs.

4. The control circuit of claim 2, wherein the controller comprises a look-up table for determining voltage values for the electrowetting lenses as a function of the zoom signal and focus signal.

5. The control circuit of claim 1, wherein the first and second voltage modulators each comprise a resistor network adapted to modulate the controllable voltage supply.

6. The control circuit of claim 4, wherein the controller is adapted to:
set the controllable voltage supply to a first level at or close to the higher of the required first and second modulated outputs;
control the first voltage modulator to produce the first modulated voltage output at or close to the first level; and
control the second voltage modulator to produce the second modulated voltage output at a second level lower than the first level.

7. A camera module, comprising:
the control circuit for electrowetting lenses including a driver circuit for producing a controllable voltage supply, a first and a second voltage modulator, each connected to receive the controllable voltage supply and adapted to respectively produce first and second modulated voltage outputs, and a controller adapted to receive at least one set point signal, to control the driver circuit to produce said voltage supply and to control the first and second voltage modulators to produce said first and second modulated outputs.

8. The camera module of claim 7, wherein control circuit comprises a look-up table adapted to provide to the controller values dependent upon the set point signals to determine the control signals for controlling the driver circuit and the first and second voltage modulators.

9. A method of controlling a focus and/or zoom operation of a camera including a first and a second electrically controllable lens, comprising:
receiving a set point signal;
based on the set point signal, determining a first and a second voltage value required for controlling respective ones of the lenses;
adjusting driver to produce a voltage output at least as high as the higher of the first and second voltage values;
controlling a first and a second voltage modulator to produce from the voltage supply a first and a second modulated voltage output corresponding to the first and second voltage values; and
driving the first and second lenses with the first and second modulated voltage outputs respectively.

10. The method of claim 9, wherein the first and second voltage modulators produce the first and second voltage outputs by pulse width modulation.

11. The method of claim 9, wherein the first and second voltage modulators produce the first and second voltage outputs via a resistor network.
